(19) United States
(12) Patent Application Publication
(10) Pub. No.: US 2023/0155393 A1
(43) Pub. Date: May 18, 2023

(54) ELECTRIC VEHICLE CHARGING SYSTEM AND METHOD

(71) Applicants: MICRO-STAR INT'L CO.,LTD., New Taipei City (TW); MSI COMPUTER (SHENZHEN) CO.,LTD., Shenzhen City (CN)

(72) Inventor: Lou Wei PENG, Taipei City (TW)

(73) Assignees: MICRO-STAR INT'L CO.,LTD., New Taipei City (TW); MSI COMPUTER (SHENZHEN) CO.,LTD., Shenzhen City (CN)

(21) Appl. No.: 17/576,845

(22) Filed: Jan. 14, 2022

(30) Foreign Application Priority Data
Nov. 18, 2021 (TW) 110142891

(51) Int. Cl. H02J 7/00; B60L 53/65; B60L 53/16; B60L 53/30; B60L 53/66

(52) U.S. Cl. CPC H02J 7/00032; B60L 53/65; B60L 53/16; B60L 53/305; B60L 53/66

(57) ABSTRACT

An electric vehicle charging system includes: an identification device configured to identify a vehicle and generate feature data associated with the vehicle, a computing device electrically coupled to the identification device, with the computing device configured to obtain a charging specification of the vehicle from a database according to the feature data, wherein the computing device generates a power-supply command associated with the charging specification, and a charging device electrically coupled to the computing device and comprising a plurality of connectors respectively having a power inserter, with the connectors configured to be electrically coupled to a plurality of vehicles with different charging specifications through the power inserters, wherein the charging device selects one of the connectors according to the power-supply command, and provides power to the selected connector.

### CROSS-REFERENCE TO RELATED APPLICATIONS

This non-provisional application claims priority under 35 U.S.C. § 119(a) on Patent Application No(s). 110,142,891 filed in Republic of China (ROC) on Nov. 18, 2021, the entire contents of which are hereby incorporated by reference.

### BACKGROUND

### 1. Technical Field

This disclosure relates to an electric vehicle charging system and method, especially to an electric vehicle charging system and method providing a plurality of charging specifications.

### 2. Related Art

Electric vehicles are the focus of the development of future vehicles all around the world, and multiple charging specifications exist due to different vehicle brands. Since different brands, or even different vehicle models of the same brand, use different chargers with different specifications and charging parameters (for example, voltage, current), which brings a lot of problems for the users as well as charger supplier.

For users, one of the problems is the user has to know which charging specification supporting his/her electric vehicle, which is definitely a problem for the user. Secondly, the user has to know the charging specifications supported by different charging station, or know the location of the charging station of a specific brand. Otherwise, the user would not be able to charge his/her electric vehicle due to incompatible charging specifications; or the charging efficiency is slow due to different charging specification; or the user has to prepare their own charging adapters, which causes inconvenience and other problems.

On the other hand, for the charger supplier, choosing which charging specification when establishing a charging station becomes the primary problem. If only a single charging specification is chosen, the charger supplier would lose clients using other charging specifications. Further, if the charger supplier intends to establish a charging station supporting different charging specifications corresponding to different brands, the charger supplier would also face the problem of higher initial construction cost, subsequent maintenance, and the possibility of discarding the charging specification in the future.

### SUMMARY

Accordingly, this disclosure provides an electric vehicle charging system and method.

According to one or more embodiment of this disclosure, an electric vehicle charging system, includes: an identification device configured to identify a vehicle and generate feature data associated with the vehicle; a computing device electrically coupled to the identification device, with the computing device configured to obtain a charging specification of the vehicle from a database according to the feature data, wherein the computing device generates a power-supply command associated with the charging specification; and a charging device electrically coupled to the computing device and comprising a plurality of connectors each having a power inserter, with the connectors configured to be electrically coupled to a plurality of vehicles with different charging specifications each through the power inserter, wherein the charging device selects one of the connectors according to the power-supply command, and supplies power to the selected connector.

According to one or more embodiment of this disclosure, an electric vehicle charging method, applied to the electric vehicle charging system, includes: identifying the vehicle by the identification device and generating the feature data; receiving the feature data by the computing device, obtaining the charging specification from the database according to the feature data by the computing device, and generating the power-supply command associated with the charging specification by the computing device; and receiving the power-supply command by the charging device, selecting one of the connectors by the charging device, and supplying the power by the charging device to the selected connector.

In view of the above description, the electric vehicle charging system and method of the present disclosure may provide a proper charging specification for the connector as well as the power parameters for adapting to various charging specifications of various types of electric vehicles. Therefore, the user would not face the problem of the charging specification of the vehicle not matching the charging station, or the problem of having to prepare his/her own adaptor. Further, the charging efficiency may be improved. In addition, the cost of establishing and cost of maintenance the charging station may be lowered for the charger supplier. The electric vehicle charging system and method of the present disclosure may allow electric vehicles in different areas or countries with various charging specifications to use the charging device.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is a system block diagram of an electric vehicle charging system according to an embodiment of the present disclosure, wherein a power-supply element is not electrically coupled to any connector;

FIG. 1B is a system block diagram of the embodiment of the electric vehicle charging system in FIG. 1A in an implementation, wherein the power-supply element is electrically coupled to one of a plurality of connectors;

FIG. 1C is a system block diagram of the embodiment of the electric vehicle charging system in FIG. 1A in another implementation, wherein the power-supply element is electrically coupled to another one of the plurality of connectors;

FIG. 2 is a system block diagram of an electric vehicle charging system according to another embodiment of the present disclosure, wherein a power-supply element is not electrically coupled to any connector;

FIG. 3 is a flow chart of an electric vehicle charging method according to an embodiment of the present disclosure; and

FIG. 4 is a flow chart of an electric vehicle charging method according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

It should be noted that, terms such as “comprise” and “include” used herein are used to indicate a feature, value, method, step, operation, element and/or component, but one or more other feature, value, method, step, operation, element and/or component or any combination of the above are also allowed to be added.

Further, “(electrical) coupling” or “(electrical) connection” in the present disclosure includes any direct and indirect electrical connection means. If the transmission or provision of electronic signals is described, a person ordinarily skilled in the art should be able to understand that the transmission of electronic signals may be accompanied by attenuation or other non-ideal changes, but the source and receiving end of the transmission or provision of electronic signals, if not specifically stated, should be regarded as the same signal.

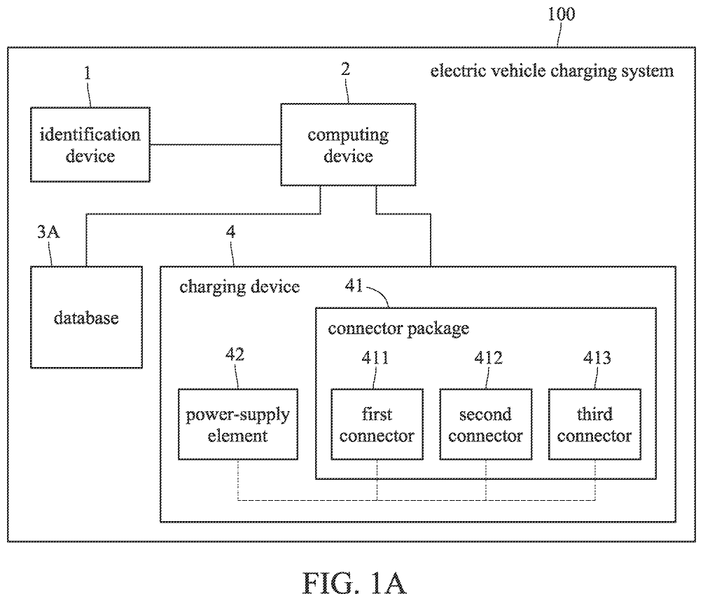

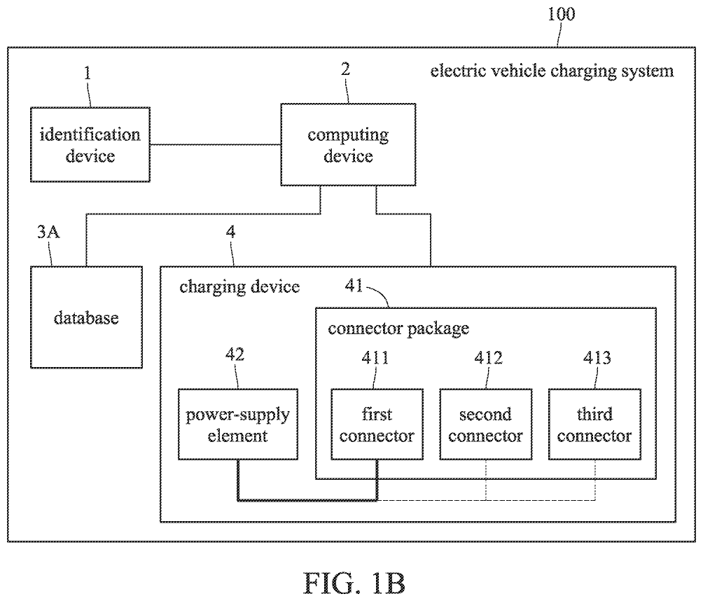

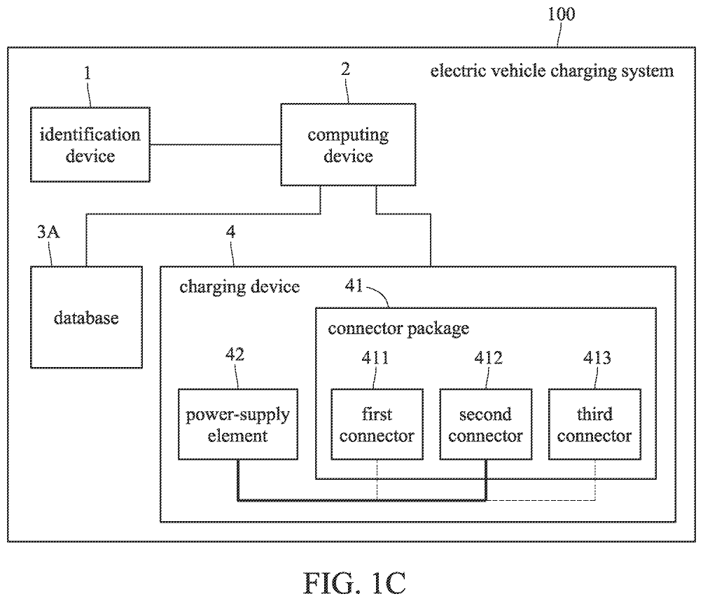

Please refer to FIG. 1A, FIG. 1A is a system block diagram of an electric vehicle charging system according to an embodiment of the present disclosure. In an embodiment, as shown in FIG. 1A, the electric vehicle charging system 100 includes an identification device 1, a computing device 2, a database 3A and a charging device 4.

The identification device 1 may be configured to identify a vehicle and generate feature data accordingly after performing identification. In an embodiment, the identification device 1 may activate identification operation when the vehicle is within a default distance from the electric vehicle charging system 100. For example, the identification device 1 may include at least one sensor of LiDAR device, an infrared radar device, an ultrasonic radar device, a millimeter wave radar (mmWave Radar) device and/or a camera. Therefore, the identification device 1 may perform identification on license plate number, vehicle body, vehicle type, vehicle model and/or vehicle brand logo. The identification device 1 may further include a digital-analog converter to generate the corresponding feature data according to the identification result obtained by the sensor. Specifically, the identification device 1 may include the millimeter wave radar device, and through the characteristic of the millimeter wave radar device not easily affected by weather (such as fog, snow, or heavy rain) or environmental factor (such as dust), the impact of the weather or environment on vehicle identification may be alleviated. Therefore, the application of the electric vehicle charging system 100 in different areas, environments or countries may be broader. Further, the identification device 1 may effectively improve the identification result under the influence of dimness at night or light exposure as well as lower the cost of establishing the electric vehicle charging system 100 by including the aforementioned infrared radar device and/or ultrasonic radar device. The body of the vehicle described above may include headlights, rear mirrors, exhaust pipes, body, etc. The above-mentioned vehicle type may include two-wheeled vehicles (bicycles, motorcycles), four-wheeled vehicles (sedans, RVs, trucks, buses, container vehicles), etc. The above-mentioned vehicle model may include two-door models, sedan models, four-door models, convertible models, etc. The above-mentioned vehicle brand logo may include the logo of the vehicle manufacturer, the text mark of the vehicle type (for example, the tail of the MiEV electric vehicle manufactured by Mitsubish has the log of “MiEV”) etc. That is, the vehicle body, vehicle type, vehicle model and/or vehicle brand logo described above all aid in the identification device 1 generating feature data other than the license plate number. The identification device 1 may generate an identification result according to the identified license plate number, vehicle body, vehicle type, vehicle model and/or vehicle brand logo. The identification device 1 may also generate a plurality of identification results according to the identified license plate number, vehicle body, vehicle type, vehicle model and/or vehicle brand logo, the present disclosure is not limited thereto.

The computing device 2 is electrically coupled to the identification device 1. The computing device 2 obtains a charging specification of the vehicle according to the feature data of the identification device 1 from the database 3A, and generates the charging specification a power-supply command accordingly. Specifically, the charging specification may include an inserter specification parameter and a power parameter, wherein the inserter specification parameter is associated with a power inserter, and the power inserter is a charging port for the electric vehicle to be connected to a charger. The inserter specification parameter may include, for example, a number of pins, shapes and sizes of the power inserter; and the power parameter is for indicating the parameter of the power supplied to the charging device 4, wherein the power parameter may include voltage value and current value of direct current (DC) signal, or voltage value and frequency of alternating current (AC) signal. In an embodiment, in the process of the computing device 2 obtaining the charging specification according to the feature data, if the identification device 1 sends a piece of feature data to the computing device 2, the computing device 2 obtains the charging specification of the vehicle from the database 3A based on the piece of feature data and generates the corresponding power-supply command. If the identification device 1 sends a plurality of pieces of feature data to the computing device 2, when the computing device 2 obtains the charging specification of the vehicle from the database 3A based on the plurality of pieces of feature data, the computing device 2 may obtain the charging specification corresponding to the plurality of pieces of feature data and generate the corresponding power-supply command. Further, the computing device 2 may obtain the charging specification based on the feature data as well as predetermined priority corresponding to the feature data, and generate the corresponding power-supply command. For example, the license plate number may be set to have a higher priority, and when there are two or more charging specifications respectively corresponding to the same number of pieces of feature data, the computing device 2 may select the charging specification corresponding to the license plate number, and generate the corresponding power-supply command. In other words, the power-supply command is associated with the selected charging specification, or at least associated with the inserter specification parameter. In an embodiment, the computing device 2 may be one or more integrated circuits, such as micro processing unit (MPU), micro control unit (MCU), or central processing unit (CPU), or any other programmable general/special purpose digital signal processor (DSP), programmable controller, application specific integrated circuit (ASIC) or other similar element or a combination of any of the above elements. That is, the computing device 2 is an element capable of performing the following computation.

In the embodiment of FIG. 1A, the database 3A may be disposed in the electric vehicle charging system 100 and is electrically coupled to the computing device 2. The database 3A may store a plurality of specification comparison entries, with each of the specification comparison entries including a first column for recording a candidate charging specification and a second column for recording vehicle information, wherein the vehicle information may correspond to a single vehicle, and include contents such as the above-mentioned license plate number, vehicle body, vehicle type, vehicle model and/or vehicle brand logo. Accordingly, in the process of the computing device 2 obtaining the charging specification from the database 3A according to the feature data, the computing device 2 obtains the charging specification by searching the vehicle information matching with the feature data from the database 3A (when the feature data is a plurality of pieces of feature data, the vehicle information may be determined as matching with the feature data when only part of the vehicle information is the same as the feature data). Then the computing device 2 determines the candidate charging specification of the first column based on the second column of the vehicle information. The computing device 2 may determine the charging specification of the vehicle is the obtained candidate charging specification. That is, as described above, if one candidate charging specification is obtained based on one piece of feature data (for example, the feature data is license plate number), this candidate charging specification is used as the charging specification of the vehicle; if a plurality of candidate charging specifications are obtained based on a plurality of pieces of feature data, the computing device 2 may determine the charging specification of the vehicle based on the number of pieces of feature data or the priority of the feature data. In an embodiment, the database 3A may be a fixed or mobile memory, such as a random access memory (RAM), a read-only memory (ROM), a flash memory), a hard disk drive (HDD), a solid state drive (SSD) or other similar element or a combination of any of the above elements.

The charging device 4 is electrically coupled to the computing device 2 and includes a connector package 41 and a power-supply element 42. The charging device 4 receives the power-supply command from the computing device 2 to determine the connection between the connector package 41 and the power-supply element 42 according to the power-supply command. Specifically, after the charging device 4 receiving the power-supply command from the computing device 2, the charging device 4 select one of a plurality of connectors 411, 412, 413 from the connector package 41 corresponding to the power-supply command, wherein the connectors 411, 412, 413 are used for the power inserter to be electrically coupled to vehicles with different charging specifications. In an embodiment, the connector package 41 includes a plurality of connectors, for example, a first connector 411, a second connector 412 or a third connector 413. The connector package 41 may be a module charging block for adapting to different charging specifications in different areas/countries. In an embodiment, the charging specification of the connectors 411, 412, 413 may include J1772 (Type1), CCS1 (Combined Charging System 1), Type2, CCS2 (Combined Charging System 2), CHAdeMO, TPC (Tesla Proprietary Connector) etc., and the connectors 411, 412, 413 may be equipped in the connector package 41 according to different areas/countries, for easier establishment/replacement of the electric vehicle charging system 100, but the present disclosure is not limited thereto. In an embodiment, the first connector 411, the second connector 412 or the third connector 413 may be GB/T 20234.2, SAE J1772 and/or IEC 62196 Type 2 respectively having AC specification, or may be GB/T 20234.3, CHAdeMO having DC specification. In another embodiment, the connectors 411, 412, 413 may further include an electric transducer (not shown) for selectively providing AC specification or DC specification, wherein the electric transducer may be a TPC to J1772 adaptor, a Type2 to J1772 adaptor, a CCS2 to CCS1 adaptor, a CHAdeMO to Tesla adaptor etc., but the present disclosure is not limited thereto. In yet another embodiment, the connectors 411, 412, 413 may further include a control circuit to adjust the power parameters, but the present disclosure is not limited thereto.

To further elaborate the charging device 4, please refer to FIGS. 1A, 1B and 1C. FIG. 1B is a system block diagram of the embodiment of the electric vehicle charging system 100 in FIG. 1A in an implementation, wherein the power-supply element 42 is electrically coupled to one of a plurality of connectors; and FIG. 1C is a system block diagram of the embodiment of the electric vehicle charging system 100 in FIG. 1A in another implementation, wherein the power-supply element 42 is electrically coupled to another one of the plurality of connectors. As shown by FIGS. 1B and 1C, the power-supply element 42 is electrically coupled to the selected connector among the plurality of connectors 411, 412, 413 according to the power-supply command to provide power to the selected connector. For example, the power-supply element 42 shown in FIG. 1B is electrically coupled to the first connector 411, and the power-supply element 42 shown in FIG. 1C is electrically coupled to the second connector 412. In an embodiment, the power-supply element 42 may be a bridge cable. For example, the connector package 41 may be disposed on a turntable (not shown), and the turntable may rotate based on the power-supply command of the computing device 2, so that the power-supply element 42 is switched and is electrically coupled to the selected connector among the plurality of connectors 411, 412, 413 of the connector package 41, but the present disclosure is not limited thereto. That is, one or more connector may be added to the connector package 41 based on requirement. In an embodiment, the power-supply element 42 may detect if any error occurs in the connectors 411, 412, 413 during charging process, wherein the detectable error may be current leakage, connector failure or damage, but the present disclosure is not limited thereto.

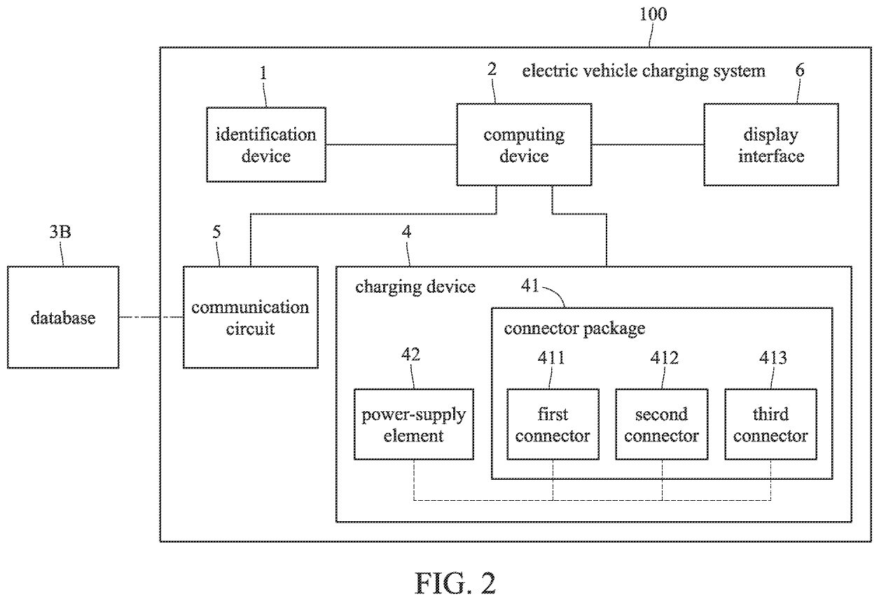

Please refer to FIG. 2. FIG. 2 is a system block diagram of an electric vehicle charging system 200 according to another embodiment of the present disclosure. Comparing to the embodiment of the electric vehicle charging system 100, the electric vehicle charging system 200 of the present embodiment does not include the database but include a communication circuit 5 instead for the computing device 2 to be connected to and external database 3B through the communication circuit 5. Further, the electric vehicle charging system 200 of the present embodiment may further include a display interface 6.

In detail, the communication circuit 5 is electrically coupled to the computing device 2 for the computing device 2 to be in communication connection with the database 3B through the communication circuit 5 and to further obtain the charging specification of the vehicle from the database 3B. In an embodiment, the communication circuit 5 may be connected to the database 3B through wired connection (for example, local network) or through wireless connection, such as radio frequency identification (RFID), near field communication (NFC), wireless fidelity (WIFI), Bluetooth, global system for mobile communications (GSM), general packet radio service (GPRS), enhanced data rates for global evolution (EDGE), wideband code division multiple access (WCDMA), code division multiple access 2000, time division-synchronous code division multiple access (TD-SCDMA), worldwide interoperability for microwave access (WIMAX), long term evolution (LTE), long term evolution advanced (LTE-A), global navigation satellite system (GNSS), vehicle to everything (V2X) etc., or the communication circuit 5 may be connected to the database 3B through an external network such as Internet. In an embodiment, when a vehicle is near the electric vehicle charging system 200 and within a predetermined distance from the electric vehicle charging system 200 or within a predetermined range from the electric vehicle charging system 200, the communication circuit 5 may be in communication connection with a telematics control unit (TCU) of the vehicle, or the communication circuit 5 may be in communication connection with an application (APP) of a terminal device (for example, the user's smart phone) to implement various services with the database 3B. For example, the various services may include registering the electric vehicle charging system 200, big data analysis based on charging data and charging specification, application of Internet of things (IOT) and application of Internet of vehicle (IOV), but the present disclosure is not limited thereto. In another embodiment, the communication circuit 5 may be connected to the vehicle for positioning through a navigation and positioning system (for example, a 5G NR PRS and C-PRS-based vehicle networking collaborative navigation and positioning system).

The display interface 6 is disposed at the front side or any side of the electric vehicle charging system 200 and is electrically coupled to the computing device 2. The display interface 6 may receive a warning command from the computing device 2, and generate at least one of an image, sound and light associated with the warning command. For example, after receiving the feature data, if the computing device 2 is unable to obtain the charging specification of the vehicle from the database 3B according to the feature data, the computing device 2 may generate and output the warning command to the display interface 6. Further, the computing device 2 may output the warning command to the display interface 6 according to the distance between the vehicle and the electric vehicle charging system 200, the charging status of the vehicle to achieve the purpose of warning the user. In an embodiment, the display interface 6 may be implemented by a screen, wherein the screen may be a touch liquid crystal display, but the present disclosure is not limited thereto. The display interface 6 may also be implemented by a liquid crystal display that is not a touch display.

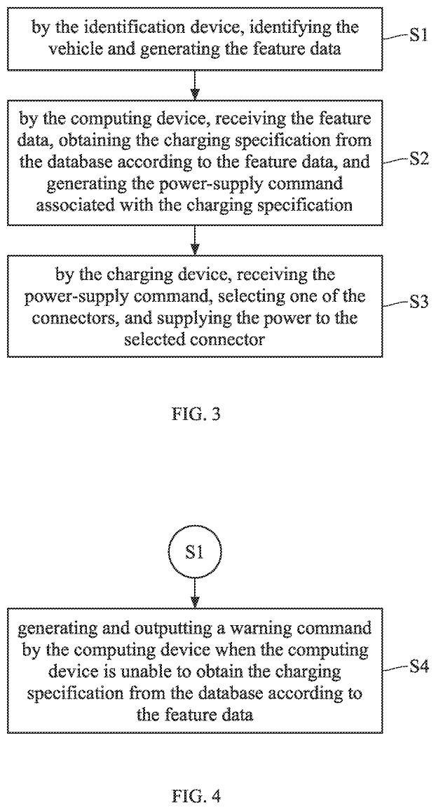

Please refer to both FIGS. 3 and 4. FIG. 3 is a flow chart of an electric vehicle charging method according to an embodiment of the present disclosure, and FIG. 4 is a flow chart of an electric vehicle charging method according to another embodiment of the present disclosure.

As shown by FIG. 3, in step S1, the identification device 1 may identify a vehicle and generate feature data associated with the vehicle.

In step S2, the computing device 2 may obtain the charging specification of the vehicle from the database 3A according to the feature data, and generate the power-supply command associated with the charging specification. The computing device 2 may also be connected to the external database 3B through the communication circuit 5 to obtain the charging specification of the vehicle according to the feature data, and generate the power-supply command associated with the charging specification.

In step S3, the charging device 4 may select one of the plurality of connectors 411, 412, 413 according to the power-supply command, and supply power to the selected connector. Specifically, the computing device 2 may select one of the plurality of connectors 411, 412, 413 from the connector package 41 of the charging device 4 according to the power-supply command, so that the power-supply element 42 is electrically coupled to the selected connector and supply power to the selected connector.

In an embodiment, in step S1, after the identification device 1 identifying the vehicle and generating the feature data, the method may continue to step S4 shown in FIG. 4 In step S4, the computing device 2 receives the feature data, and when the computing device 2 is unable to receive the charging specification from the databases 3A, 3B according to the feature data, the computing device 2 may generate and output the warning command. More specifically, if the computing device 2 is unable to receive the charging specification from the databases 3A,3B according to the feature data, the computing device 2 may generate and output the warning command, and generate at least one of an image, sound and light associated with the warning command. The computing device 2 preferably outputs the warning command to the display interface 6.

In addition to the above embodiments, the electric vehicle charging system and method of the present application may be further applied to Device to Device (D2D) communication system such as IOT communication system, vehicular ad-hoc network (VANET) communication system, IOV communication system, but the present disclosure is not limited thereto.

The electric vehicle charging system and method of the present disclosure may provide a proper charging specification for the connector as well as the power parameters for adapting to various charging specifications of various types of electric vehicles. Therefore, the user would not face the problem of the charging specification of the vehicle not matching the charging station, or the problem of having to prepare his/her own adaptor. Further, the charging efficiency may be improved. In addition, the cost of establishing and cost of maintenance the charging station may be lowered for the charger supplier. The electric vehicle charging system and method of the present disclosure may allow electric vehicles in different areas or countries with various charging specifications to use the charging device.

What is claimed is:

1. An electric vehicle charging system, comprising:
an identification device configured to identify a vehicle and generate feature data associated with the vehicle;
a computing device electrically coupled to the identification device, with the computing device configured to obtain a charging specification of the vehicle from a database according to the feature data, wherein the computing device generates a power-supply command associated with the charging specification; and
a charging device electrically coupled to the computing device and comprising a plurality of connectors each having a power inserter, with the connectors configured to be electrically coupled to a plurality of vehicles with different charging specifications each through the power inserter, wherein the charging device selects one of the connectors according to the power-supply command, and supplies power to the selected connector.

2. The electric vehicle charging system according to claim 1, further comprising a communication circuit electrically coupled to the computing device, with the communication circuit configured to connect the computing device and the database in communication.

3. The electric vehicle charging system according to claim 1, further comprising the database electrically coupled to the computing device, with the database storing a plurality of specification comparison entries, and each of the specification comparison entries comprising a candidate charging specification and at least one piece of vehicle information.

4. The electric vehicle charging system according to claim 1, wherein the charging device further comprises a power-supply element electrically coupled to the selected connector according to the power-supply command to supply the power to the selected connector.

5. The electric vehicle charging system according to claim 1, wherein the identification device comprises at least one of a lidar, an infrared radar, an ultrasonic radar, a millimeter wave radar and a camera.

6. The electric vehicle charging system according to claim 1, further comprising a display interface electrically coupled to the computing device, with the display interface receiving a warning command from the computing device and generating at least one of an image, sound and light associated with the warning command.

7. The electric vehicle charging system according to claim 1, wherein the charging specification comprises an inserter specification parameter and a power parameter, with the inserter specification parameter associated with the power inserter of the selected connector, and the power parameter associated with the power supplied to the selected connector.

8. An electric vehicle charging method, applied to the electric vehicle charging system according to claim 1, comprising:
identifying the vehicle by the identification device and generating the feature data;
receiving the feature data by the computing device, obtaining the charging specification from the database according to the feature data by the computing device, and generating the power-supply command associated with the charging specification by the computing device; and
receiving the power-supply command by the charging device, selecting one of the connectors by the charging device, and supplying the power by the charging device to the selected connector.

9. The electric vehicle charging method according to claim 8, wherein the electric vehicle charging system further comprises a communication circuit electrically coupled to the computing device, and receiving the feature data, and obtaining the charging specification from the database by the computing device comprises:
connecting, in communication, to the database to receive the feature data by the computing device through the communication circuit, and obtaining the charging specification from the database according to the feature data.

10. The electric vehicle charging method according to claim 8, wherein after identifying the vehicle and generating the feature data, the electric vehicle charging method further comprising:
generating and outputting a warning command by the computing device when the computing device is unable to obtain the charging specification from the database according to the feature data.
